(19) United States
(12) Patent Application Publication
(10) Pub. No.: US 2013/0002011 A1
(43) Pub. Date: Jan. 3, 2013

(54) TRACK PIN RETENTION SYSTEM

(76) Inventors: Robert Lee Meyer, Metamora, IL (US); Mircea Dumitru, Washington, IL (US); Ajay Dnyandeo Yadav, Peoria, IL (US); Mark Steven Diekevers, Metamora, IL (US); Dennis Robert Shookman, Washington, IL (US)

(21) Appl. No.: 13/173,382

(22) Filed: Jun. 30, 2011

(51) Int. Cl. B62D 55/21

(52) U.S. Cl. 305/202

(57) ABSTRACT

A chain link for a track of a mobile machine includes a pin, and a retention ring coupled to the pin at a mechanical joint. A portion of the retention ring fills imperfections of the pin at the joint and the pin remains substantially metallurgically separate from the retention ring. The chain link also includes a first track link defining a hole having a step. The first track link is mounted on the pin such that the retention ring is disposed substantially within the step.

### TECHNICAL FIELD

The present disclosure relates generally to track links of a mobile machine and, more particularly, to a track pin retention system for track type mobile machines.

### BACKGROUND

A track type mobile machine utilizes tracks on either side of the machine that are connected to ground engaging elements known as shoes to move the machine. Specifically, a sprocket driven by an engine of the machine engages links of the track to translate the track about spaced apart pulley mechanisms. As the track translates about the pulley mechanisms, connected shoes engage a work surface under the machine to transmit torque from the sprocket to the surface in a direction opposite the desired travel direction of the machine, thereby propelling the machine. Depending on the weight of the machine, size of the track, the environment in which the machine is operating, and other similar factors, the track links and/or shoes may wear or be damaged and require periodic inspection, servicing, repair, and/or replacement.

In addition, if appropriate track pin retention mechanisms are not employed, one or more pins associated with the track links may work themselves free from the track links, thereby causing the track to malfunction. While such pin retention mechanisms are known, such mechanisms are generally quite complicated and typically require welding or mechanically swagging the pin to the track links. Due to the strength of the metallurgical bond formed by these processes, such pin retention mechanisms do not permit disassembly and repair of the track links in the field, and are generally disfavored as a result. In addition, while it may be desirable to employ track links made from materials having relatively high strength and/or hardness characteristics, the welding or mechanical swagging processes employed by known pin retention mechanisms are difficult to use with such materials. Utilizing mechanical swagging, weldments, and/or other known coupling processes may also require that the pin and the track links be made from the same material, thereby placing a further constraint on manufacturing such components.

A known track pin retention mechanism is discussed in U.S. Patent Application Publication No. 2010/0090523 (“the '523 publication”) to Grenzi, published on Apr. 15, 2010. The '523 publication teaches a track joint seal system including a pin and a track link rotatably coupled to the pin. The system also includes a bushing disposed on the pin, and an end element coupled to the end of the pin. The system further includes a seal ring, a spacer ring, a preloaded ring, a metal core, a bushing insert, a rigid insert, an elastic ring, a collar, and a safety ring.

Although the pin retention mechanism of the '523 publication may address some of the problems discussed above, the disclosed system requires a large number of parts and is complicated to manufacture and assemble. In addition, utilizing such a large number of parts for each track link reduces the reliability of the system and increases the overall cost of the system. Finally, the collar of the '523 publication is typically welded to the pin, thereby limiting the materials capable of being utilized for the pin and/or the collar.

The disclosed chain links and/or other track pin retention systems are directed to overcoming one or more of the problems set forth above.

### SUMMARY OF THE INVENTION

In an exemplary embodiment of the present disclosure, a chain link for a track of a mobile machine includes a pin, and a retention ring coupled to the pin at a mechanical joint. A portion of the retention ring fills imperfections of the pin at the joint and the pin remains substantially metallurgically separate from the retention ring. The chain link also includes a first track link defining a hole having a step. The first track link is mounted on the pin such that the retention ring is disposed substantially within the step.

In another exemplary embodiment of the present disclosure, a chain link for a track of a mobile machine includes a pin, a first retention ring fixedly coupled to the pin through a capacitive discharge joining process, and a bushing rotatably mounted on the pin substantially adjacent to the first retention ring. The chain link also includes a second retention ring fixedly coupled to the pin through the capacitive discharge joining process substantially adjacent to the bushing. The bushing is disposed between the first and second retention rings. The chain link further includes a first track link coupled to the pin and forming a step. The first retention ring is disposed substantially within the step.

In a further exemplary embodiment of the present disclosure, a method of forming a chain link for a track of a mobile machine includes rotatably coupling a bushing onto a pin and fixedly coupling a first retention ring onto the pin substantially adjacent to the bushing. The retention ring fills asperities formed by the pin while remaining substantially metallurgically separate from the pin. The method also includes press fitting a first track link onto the pin such that the first retention ring is disposed within a first step formed by the first track link.

### BRIEF DESCRIPTION OF THE DRAWINGS

FIG. 1 is a pictorial illustration of an exemplary disclosed machine;

FIG. 2, is an exploded view of an exemplary chain link; and

FIG. 3 is a cross sectional view of the chain link shown in FIG. 2.

### DETAILED DESCRIPTION

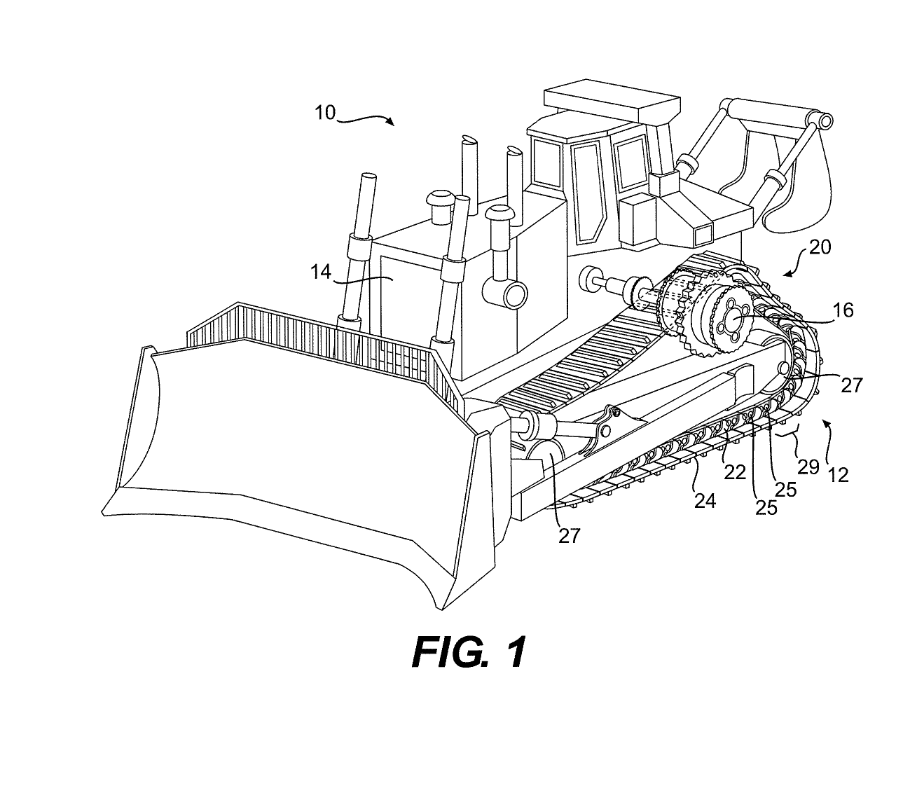

FIG. 1 illustrates a track type mobile machine 10 having a power source 14 driving a tracked undercarriage 12. Machine 10 may be a mobile machine that performs an operation associated with an industry such as mining, construction, farming, or any other industry known in the art. For example, machine 10 may be an earth moving machine such as a dozer, a loader, an excavator, or any other earth moving machine.

Power source 14 may drive tracked undercarriage 12 of machine 10 at a range of output speeds and torques. Power source 14 may be an engine such as, for example, a diesel engine, a gasoline engine, a gaseous fuel-powered engine, or any other suitable engine. Power source 14 may also be a non-combustion source of power such as, for example, a fuel cell, a power storage device, or any other source of power known in the art.

Tracked undercarriage 12 may include tracks 20 (only one shown in FIG. 1) driven by power source 14 via sprockets 16 (only one shown in FIG. 1). Each track 20 may include a chain 22 with attached ground control devices called shoes 24. Each chain 22 may comprise a plurality of chain links 29 connected to each other by rod assemblies 25. Sprockets 16 may engage and transmit a torque to rod assembly 25 to thereby move the chain 22 about spaced apart pulley mechanisms 27.

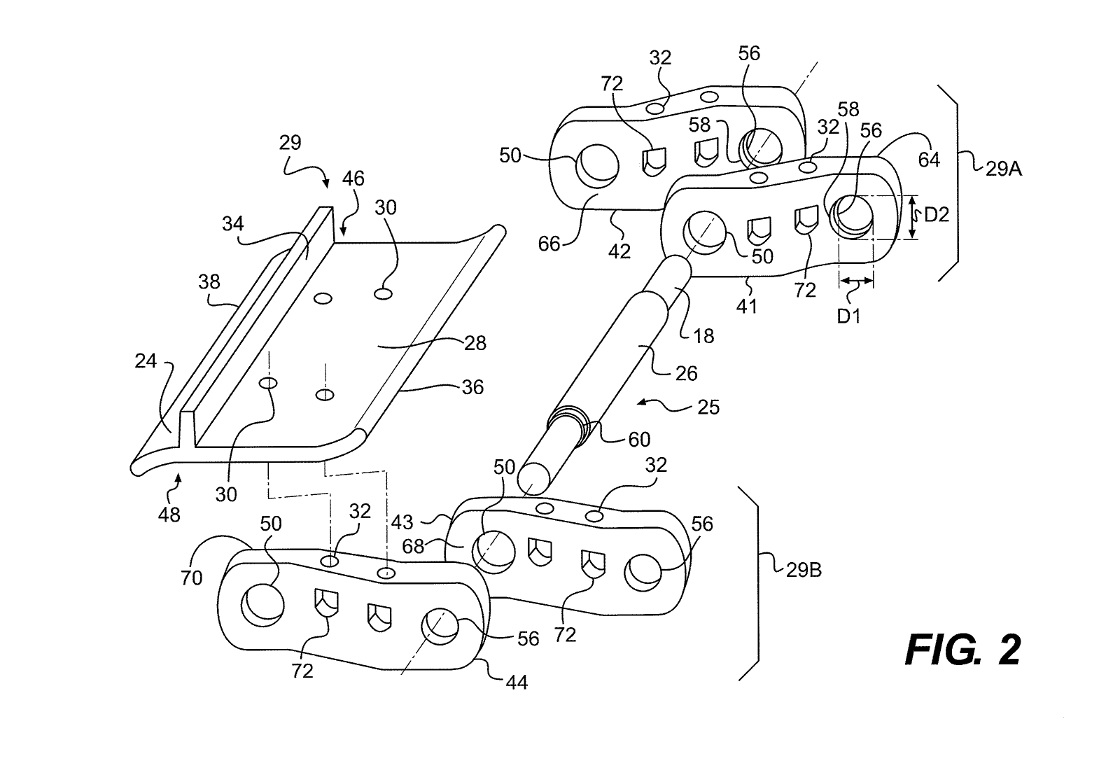

As illustrated in FIG. 2, each chain link 29 may include two opposing sides 29A and 29B, at least one shoe 24, and at least one rod assembly 25. Each side 29A and 29B of chain link 29 may include two track links, and each rod assembly 25 may include a pin 18, a bushing 26, and at least one retention ring 60. For example, a first track link 41 and a second track link 42 may form the first side 29A, and a third track link 43 and a fourth track link 44 may form the second side 29B. As described above, sides 29A and 29B may be disposed opposite each other and may be connected by one or more rod assemblies 25. Track links 42, 44 may be disposed proximate respective outer edges 46, 48 of the shoe 24, and track links 41, 43 may be disposed inward of track links 42, 44. In exemplary embodiments, track links 42, 44 may be coupled to a first shoe 24 and track links 41, 43 may be coupled to a separate second shoe (not shown).

In an exemplary embodiment, shoe 24 may be joined to track links 42, 44 by way of a plurality of threaded fasteners (not shown), thru holes 30 formed in the shoe 24, and corresponding thru holes 32 formed in track links 41, 42, 43, 44. That is, each shoe 24 may be joined to at least two of the track links 41, 42, 43, 44 by substantially aligned (i.e. aligned in travel direction) cap screw type fasteners, bolts, and/or other like threaded fasteners recessed within respective thru holes 30 formed in shoe 24. Each thru hole 32 may be configured to receive such threaded fasteners, and each track link 41, 42, 43, 44 may include a passage 72 substantially aligned with each respective thru hole 32. Such passages 72 may comprise, for example, an elongated thru hole formed in the track shoe 41, 42, 43, 44. The passages may facilitate attachment and/or tightening of, for example, a nut or other like fastening structure on the end of each threaded fastener. Thus, such a threaded fastener may extend through the thru holes 32 such that an end of the threaded fastener is exposed in the passages 72. Such passages 72 may be shaped, sized, and/or located to allow an operator to the end of the threaded fastener with a wrench or other like tool for tightening, for example, a nut, washer, and/or other like fastening structure. In further exemplary embodiments, each track link 41, 42, 43, 44 extending beneath both thru holes 32 such that the ends of threaded fasteners disposed within the thru holes 32 may be accessed via the single passage 72. In still further exemplary embodiments, the passage 72 may extend only partially through the track links 41, 42, 43, 44 while still facilitating access to the ends of the threaded fasteners.

Shoe 24 may include a substantially rectangular planar base 28 forming a ground-engaging surface of the shoe 24. The shoe 24 may also include an outwardly extending grouser bar 34, a leading edge 36, and a trailing edge 38. One or more grouser bars 34 may be integrally formed with, welded to, or otherwise connected to the base 28 of each shoe 24.

As illustrated in FIG. 2, track link 41 may be substantially structurally identical to track link 43, and track link 42 may be substantially structurally identical to track link 44. For example, track links 41, 43 may be positioned internal to corresponding track links 42, 44 along a width of the shoe 24. In such an exemplary embodiment, face 64 of track link 41 may be disposed substantially adjacent to face 66 of track link 42 proximate outer edge 46 of the shoe 24. In such an exemplary embodiment, face 68 of the track link 43 may be disposed substantially adjacent to face 70 of the track link 44 proximate the outer edge 48 of the shoe 24.

Each of the track links 41, 42, 43, 44 may define a plurality of additional thru holes configured to accept at least a portion of the rod assembly 25. For example, each of the track links 41, 42, 43, 44 may form and/or otherwise include a thru hole 50 shaped, sized, positioned, and/or otherwise configured to accept the pin 18 and the bushing 26. The thru hole 50 may be positioned as desired along the track links 41, 42, 43, 44 to facilitate movement and/or functionality of the chain link 29. In an exemplary embodiment, the thru holes 50 may be sized to provide a pressed fit between at least a portion of the bushing 26 and the corresponding track links 41, 42, 43, 44. It is understood that the thru holes 50 may define a diameter slightly smaller than a corresponding diameter of the bushing 26 to facilitate such a pressed fit. In further exemplary embodiments, the bushing 26 may comprise more than one outer diameter, and in such exemplary embodiments, at least one of the outer diameters defined by the bushing 26 may correspond to the diameter of the respective thru holes 50. In this way, the bushing 26 may remain substantially stationary relative to the track links 41, 42, 43, 44 coupled thereto during use of the chain link 29.

Track links 41, 42, 43, 44 may also define thru holes 56 similar to the thru holes 50 described above. Each thru hole 56 may define at least one annular step 58. The step 58 may be shaped, sized, and/or otherwise configured to overlay, cover, and/or otherwise accept the retention ring 60 disposed on the pin 18. For example, each thru hole 56 may define a first diameter D1 that is slightly smaller than an outer diameter of the pin 18 in order to provide a pressed fit between the corresponding track links 41, 42, 43, 44 and the outer diameter of the pin 18. Due to this pressed fit, the track links 41, 42, 43, 44 may remain substantially stationary relative to the pin 18 during use of the chain link 29. The thru holes 56 may also define a second diameter D2 corresponding to the annular step 58. In an exemplary embodiment, the second diameter D2 of the annular step 58 may be slightly larger than the first diameter D1 in order to accept the retention ring 60. In exemplary embodiments, the depth, width, height, and/or other configurations of the step 58 may be selected based on the corresponding dimensions of the retention ring 60, and the configurations of the step 58 may be chosen to allow for sufficient clearance between, for example, the retention ring 60 and the corresponding track links 41, 42, 43, 44. Accordingly, in exemplary embodiments, the annular step 58 may be sized and positioned such that the retention ring 60 may be disposed substantially within the step 58 once the respective track links 41, 42, 43, 44 have been coupled to the pin 18.

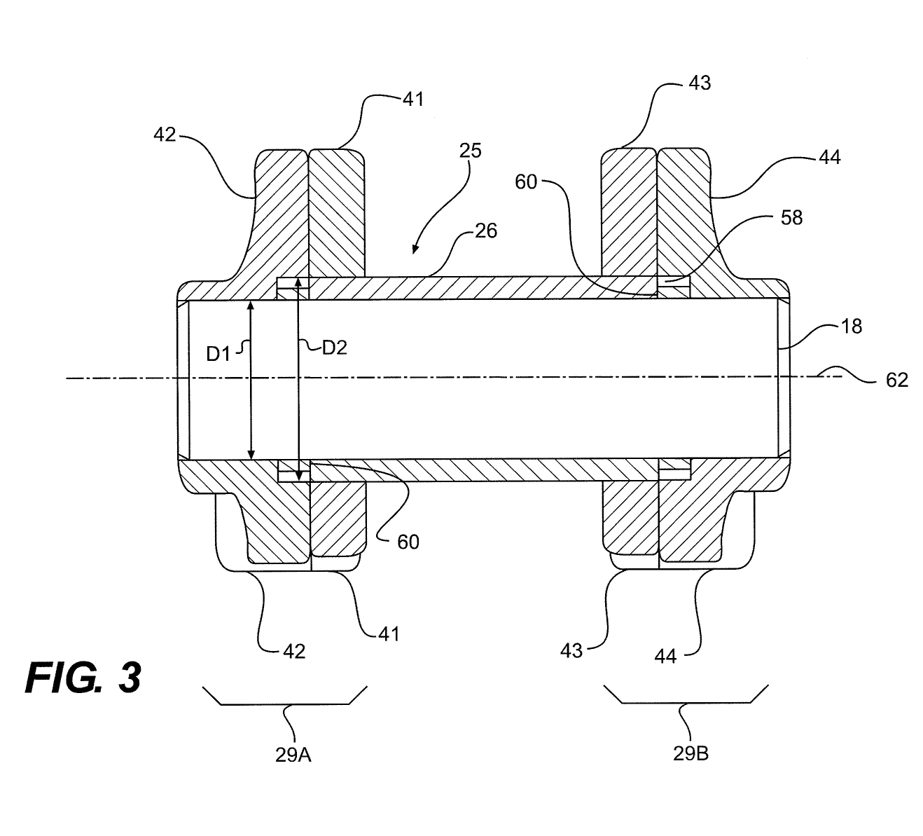

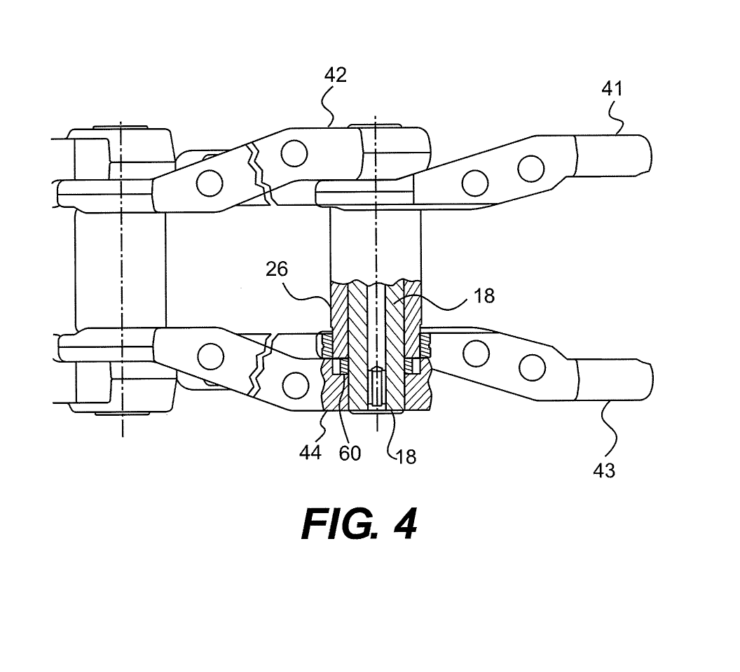

The bushing 26 may comprise a collar, a sleeve, and/or any other like structure, and the bushing 26 may be rotatably mounted on the pin 18. In an exemplary embodiment, the bushing 26 may be rotatable about a longitudinal axis 62 (FIG. 3) of the pin 18, and may include any number of bearings and/or other like structures to facilitate such rotatability. For example, the bushing 26 may comprise two or more sleeves, collars, and/or other like components (not shown) having bearings disposed therebetween to facilitate such rotation. Due to this configuration, components such as the track links 41, 43 that are press fitted and/or otherwise fixedly coupled to the bushing 26 may also be rotatable relative to the pin 18 about the longitudinal axis 62.

Retention ring 60 may be fixedly coupled to the pin 18 at any desired location thereon. In an exemplary embodiment, the rod assembly 25 may include a single retention ring 60, and in additional exemplary embodiments, the rod assembly 25 may include a pair of retention rings 60. In such embodiments, a first retention ring 60 may be disposed on a first side of the bushing 26, and a second retention ring may be disposed on a second side of the bushing 26 opposite the first side. In an exemplary embodiment, such retention rings 60 may assist in maintaining the bushing 26 at a substantially fixed location along the length of the pin 18 while still allowing the bushing 26 to rotate about the longitudinal axis 62. In additional exemplary embodiments, at least one retention ring 60 may assist in retaining the pin 18 at a substantially fixed location relative to, for example, the track links 42, 44 during use of the chain link 29. The retention ring 60 may be fixedly coupled to the outer circumference of the pin 18 in any desirable fashion. In an exemplary embodiment, the retention ring 60 may be coupled to the pin 18 using weldments, mechanical swagging, grooves, seals, and/or other positive pin retention methods known in the art.

In additional exemplary embodiments, the retention ring 60 may be coupled to the pin 18 via a capacitve discharge joining process. This process is also known as, for example, “magnetic pulse welding.” Such a process may take advantage of minute imperfections in, for example, the outer circumference of the pin 18 and/or the inner circumference of the retention ring 60 to form a tight mechanical joint between the pin 18 and the retention ring 60. It is understood that such imperfections may result from the machining and/or other processes by which the pin 18 and/or the retention ring 60 are formed. For example, even though the finished surfaces of these components may appear to be smooth and/or flat to the naked eye, such surfaces may still be relatively rough when viewed under magnification. In particular, such surfaces may contain, form, and/or define micrometer-scale peaks, troughs, and/or other imperfections known as “asperities.” During the capacitive discharge joining process, material from a portion of the retention ring 60 may substantially fill at least a portion of the asperities defined by the outer circumference of the pin 18 and/or material from a portion of the pin 18 may fill at least a portion of the asperities defined by the inner circumference of the retention ring 60. While the pin 18 and the retention ring 60 may remain substantially metallurgically separate from each other (i.e., substantially separate at the atomic level) at the mechanical joint formed by the capacitive discharge joining process, substantially filling at least a portion of the asperities in this way may result in these two components being mechanically interlocked.

During an exemplary capacitive discharge joining process, the pin 18 and the retention ring 60 may be subjected to one or more directed pulses of electromagnetic energy. In exemplary embodiments, the one or more pulses of energy may have a magnitude between approximately 20 kJ and approximately 60 kJ. Upon being subjected to such pulses, the material of the retention ring 60 may be forced into and/or may otherwise substantially fill at least a portion of the imperfections on the outer circumference of the pin 18 and/or the material of the pin 18 may be forced into and/or may otherwise substantially fill at least a portion of the imperfections on the inner circumference of the retention ring 60, as described above. Despite the magnitude of such pulses, the capacitive discharge joining process may not result in substantial changes in the circumferences, diameters, and/or other dimensions of the pin 18 and/or the retention ring 60. Although it may be possible, through the capacitive discharge joining processes, to form a metallurgical bond atomically linking portions of the retention ring 60 with portions of the pin 18, such a bond may not be desirable in all applications. For example, such a bond may not enable the retention ring 60 to be easily disconnected from the pin 18 in the field and, thus, may suffer from the same disadvantages discussed above with regard to the welding process.

The retention ring 60 may serve as a positive stop, prohibiting walking of the pin 18 out of the track links 41, 42, 43, 44 during use, and the retention force provided by capacitive discharge joining the retention ring 60 to the pin 18 may be adjusted and/or otherwise desirably chosen through appropriate selection of the dimensions of the retention ring 60. Such retention force may also be desirably chosen through selection of the materials utilized to form the pin 18 and/or the retention ring 60. For example, the diameter and thickness of the retention ring 60 may both be directly proportional to the retention force provided by the bond between the retention ring 60 and the pin 18. In exemplary embodiments, capacitive discharge joining the retention ring 60 to the pin 18 may provide a retention force coupling the retention ring 60 to the pin 18 of between approximately 70 kN and approximately 80 kN. In such exemplary embodiments, the retention ring 60 may be formed from any desirable metal and/or alloy known in the art, and such materials may include copper and aluminum. In addition, in such exemplary embodiments, the pin 18 may be formed from a dissimilar material such as steel. In additional exemplary embodiments having a relatively larger pin 18 and retention ring 60, the retention force coupling the retention ring 60 to the pin 18 may be greater than 80 kN such as, for example, between approximately 190 kN and approximately 200 kN. In still further exemplary embodiments having a relatively smaller pin 18 and retention ring 60, the retention force coupling the retention ring 60 to the pin 18 may be less than 70 kN such as, for example, between approximately 30 kN and approximately 40 kN.

In order for the retention ring 60 to be coupled to the pin 18 through the capacitive joining processes, it is understood that the pin 18 and the retention ring 60 may be formed from electrically conductive metals. As discussed above, during such a process, substantially all microscopic defects, irregularities, and/or spaces between the outer circumference of the pin 18 and an inner diameter of the retention ring 60 may be minimized and/or substantially eliminated. As a result, a mechanical joint having an interference and/or friction fit may be formed between the outer circumference of the pin 18 and the inner circumference of the retention ring 60.

### INDUSTRIAL APPLICABILITY

The systems of the present disclosure may be applicable to any track type machine where durability of the track is required. The chain links 29 described herein may improve durability of the tracked undercarriage by ensuring proper assembly and eliminating walking out of the pin 18 during use. Further, the present disclosure may reduce operating cost by allowing efficient replacement of chain link components in the event of a failure.

By utilizing a capacitive discharge joining process to couple a retention ring 60 to the pin 18, as described above, the disadvantages associated with swagging or welding the track links 41, 42, 43, 44 to the pin 18 may be avoided. For example, the capacitive discharge joining process may enable use of track links 41, 42, 43, 44 foamed from materials having more robust hardness characteristics without requiring that the pin 18 be formed from these same materials. Since such materials may be difficult to machine, and may be more expensive, it may be desirable to limit the use of such materials to high-wear parts such as the track links 41, 42, 43, 44.

Coupling the retention ring 60 to the pin 18 through the capacitive discharge joining process may also enable the retention ring 60 to be removed from the pin 18 for replacement in the field without, for example, requiring weldments or other similar metallurgical bonds to be broken between the two joined parts. Utilizing such capacitive discharge joining processes may have additional benefits known in the art such as, for example, requiring relatively little heat, producing negligible distortion to either the pin 18 or the retention ring 60, and coupling such components at relatively high speeds. For example, such processes may be capable of coupling the retention ring 60 and the pin 18 in approximately 20 us or less. In addition, since such processes facilitate the coupling of two dissimilar electrically conductive materials, such processes enable the user to choose from a larger set of materials from which to construct the pin 18 and/or the retention ring 60.

As best shown in FIGS. 2 and 3, the chain link 29 may be assembled, manufactured, and/or otherwise formed by positioning at least one retention ring 60 at a desired location along an outer circumference of the pin 18. The retention ring 60 may be capacitive discharge joined (i.e. magnetic pulse welded) to the pin 18 at any appropriately position along the pin 18. Coupling the retention ring 60 to the pin 18 in this way may, for example, eliminate the requirement for forming grooves on the pin 18 and/or other like positive retention systems/structures known in the art. It is understood that such grooves and/or other pin retention systems may form undesirable stress concentration points along the pin 18 and, thus, may be more likely to fail during use. In addition, capacitive discharge joining the retention ring 60 onto the pin 18 may eliminate the need for mechanical swagging and/or welding, for example, one or more of the track links 41, 42, 43, 44 to the pin 18 in order to positively retain the pin 18 therein.

During assembly, the bushing 26 may be coupled to the pin 18. In particular, the bushing 26 may be rotatably coupled to the outer circumference of the pin 18, and the bushing 26 may be disposed substantially adjacent to the retention ring 60. In additional exemplary embodiments, a second retention ring 60 may be capacitive discharge joined to the outer circumference of the pin 18. In such exemplary embodiments, the second retention ring 60 may also be positioned substantially adjacent to the bushing 26. Thus, the bushing 26 may be disposed between the retention rings 60 and may be prevented from moving laterally along the pin 18, while still being rotatable about the longitudinal axis 62 of the pin 18.

In such exemplary methods, a first track link 41 may be coupled to the bushing 26. For example, the track link 41 may be press fit onto the outer circumference of the bushing 26. In additional exemplary embodiments, the track link 43 may be press fit onto the bushing 26 in a similar manner as the track link 41. As shown in FIG. 3, the track links 41, 43 may be disposed on opposite ends of the bushing 26. Due to this configuration, the track links 41, 43 may be substantially fixedly coupled to the bushing 26, and may be rotatable with the bushing 26 about the longitudinal axis 62.

During assembly, the track link 42 may be substantially fixedly coupled to the outer circumference of the pin 18, and the track link 42 may abut the track link 41 so as to be disposed substantially adjacent thereto. For example, the track link 42 may be press fit onto the outer circumference of the pin 18. As described above, the track link 42 may define at least one annular step 58, and the track link 42 may be disposed on the pin 18 such that the retention ring 60 may be disposed within the annular step 58 formed by the track link 42. Due to this configuration, the track link 42 may be configured to rotate with the pin 18. Rotation of the track link 42 may be independent of rotation by the bushing 26 and/or the track links 41, 43. In addition, the retention ring 60 may be fixedly coupled to the pin 18 so as to prevent the pin 18 from walking out of, for example, the track link 42. In particular, the retention ring 60 may act as a positive stop for the pin 18, and interaction between the bushing 26, the retention ring 60, and the annular step 58 of the track link 42 may prevent the pin 18 from moving laterally in a direction parallel to the longitudinal axis 62 relative to the track link 42 once the chain link 29 has been assembled and/or otherwise formed.

A method of forming such a chain link 29 may also include press fitting the track link 44 onto the outer circumference of the pin 18. As described above, the track link 44 may be substantially identical to the track link 42, and the track link 43 may be substantially identical to the track link 41. The holes 56 of track links 41, 42, 43, 44 may also define one or more annular steps 58. In such an exemplary embodiment, a second retention ring 60 capacitive discharge joined onto the pin 18 may be disposed within the step 58 defined by the holes 56. A shoe 24 (FIG. 2) may then be coupled to at least two of the track links 41, 42, 43, 44 via one or more of the threaded fasteners and thru holes 30, 32 described above. The formed chain link 29 may then be joined to one or more additional like chain links 29 to form a completed chain 22. Such a chain 22 may be incorporated into the track 20 of a machine 10 for any of the uses described above.

It will be apparent to those skilled in the art that various modifications and variations can be made to the disclosed track pin retention systems. Other embodiments will be apparent to those skilled in the art from consideration of the specification and practice of the disclosed systems. For example, while the pin 18 and the bushing 26 have been described herein as being substantially cylindrical, and the retention rings 60 and steps 58 have been described herein as being substantially annular, in additional exemplary embodiments, such components may have any other known shape, cross section, and/or configuration useful in the operation of the disclosed chain links 29. It is intended that the specification and examples be considered as exemplary only, with a true scope being indicated by the following claims and their equivalents.

What is claimed is:

1. A chain link for a track of a mobile machine, comprising:
a pin;
a retention ring coupled to the pin at a mechanical joint, a portion of the retention ring filling imperfections of the pin at the joint, the pin remaining substantially metallurgically separate from the retention ring; and
a first track link defining a hole having a step, the first track link mounted on the pin such that the retention ring is disposed substantially within the step.

2. The chain link of claim 1, further comprising a second track link disposed substantially adjacent to the first track link.

3. The chain link of claim 2, further comprising a bushing rotatably mounted on the pin, the second track link press fit onto the bushing.

4. The chain link of claim 3, wherein the bushing is disposed substantially adjacent to the retention ring.

5. The chain link of claim 1, wherein the imperfections comprise asperities.

6. The chain link of claim 1, wherein a retention force coupling the retention ring to the pin is between approximately 70 kN and approximately 80 kN.

7. The chain link of claim 1, wherein the retention ring is formed of a first material and the pin is formed of a second material different than the first material.

8. The chain link of claim 7, wherein the retention ring is capacitive discharge joined to the pin.

9. A chain link for a track of a mobile machine, comprising:
a pin;
a first retention ring fixedly coupled to the pin through a capacitive discharge joining process;
a bushing rotatably mounted on the pin substantially adjacent to the first retention ring;
a second retention ring fixedly coupled to the pin through the capacitive discharge joining process substantially adjacent to the bushing, the bushing disposed between the first and second retention rings; and
a first track link coupled to the pin and forming a step, the first retention ring being disposed substantially within the step.

10. The chain link of claim 9, further comprising a second track link coupled to the bushing.

11. The chain link of claim 10, wherein the second track link is disposed substantially adjacent to the first track link.

12. The chain link of claim 10, further comprising a shoe having a first side coupled to the first and second track links, and a second side opposite the first side defining a ground engaging surface.

13. The chain link of claim 10, wherein the first retention ring fills asperities formed by the pin.

14. The chain link of claim 10, wherein the capacitive discharge joining process comprises subjecting the pin and the first retention ring to an electromagnetic pulse having a magnitude between approximately 25 kJ and approximately 60 kJ.

15. A method of forming a chain link for a track of a mobile machine, comprising:
rotatably coupling a bushing onto a pin;
fixedly coupling a first retention ring onto the pin substantially adjacent to the bushing, the retention ring filling asperities formed by the pin while remaining substantially metallurgically separate from the pin; and
press fitting a first track link onto the pin such that the first retention ring is disposed within a first step formed by the first track link.

16. The method of claim 15, further comprising press fitting a second track link onto the bushing substantially adjacent to the first track link.

17. The method of claim 16, further comprising capacitive discharge joining a second retention ring onto the pin substantially adjacent to the bushing.

18. The method of claim 17, further comprising press fitting a third track link onto the pin, the third track link being substantially identical to the first track link and defining a second step, the second retention ring being disposed substantially within the second step.

19. The method of claim 18, further comprising press fitting a fourth track link onto the bushing, the fourth track link being substantially identical to the second track link.

20. The method of claim 18, wherein fixedly coupling the first retention ring onto the pin comprise capacitive discharge joining the first retention ring and the pin.
